(19) United States
(12) Patent Application Publication
(10) Pub. No.: US 2023/0385705 A1
(43) Pub. Date: Nov. 30, 2023

(54) MACHINE LEARNING DEVICE, MACHINE LEARNING METHOD, AND NON-TRANSITORY COMPUTER-READABLE RECORDING MEDIUM HAVING EMBODIED THEREON A MACHINE LEARNING PROGRAM

(71) Applicant: JVCKENWOOD Corporation, Yokohama-shi (JP)

(72) Inventors: Hideki TAKEHARA, Yokohama-shi (JP); Shingo KIDA, Yokohama-shi (JP); Yincheng YANG, Yokohama-shi (JP)

(21) Appl. No.: 18/447,347

(22) Filed: Aug. 10, 2023

Related U.S. Application Data
(63) Continuation of application No. PCT/JP2021/045349, filed on Dec. 9, 2021.

(30) Foreign Application Priority Data
Feb. 10, 2021 (JP) 2021-019468

(51) Int. Cl. G06N 20/00

(52) U.S. Cl. CPC G06N 20/00

(57) ABSTRACT

A domain adaptation data richness determination unit determines, when a first model trained by using training data of a first domain is trained by transfer learning by using training data of a second domain, a domain adaptation data richness based on the number of items of training data of the second domain, the first model being a neural network. A learning layer determining unit determines a layer in the second model, which is a duplicate of the first model, targeted for training, based on the domain adaptation data richness. A transfer learning unit applies transfer learning to the layer in the second model targeted for training, by using the training data of the second domain.

### CROSS REFERENCE TO RELATED APPLICATION

This application is a continuation of application No. PCT/JP2021/045349, filed on Dec. 9, 2021, and claims the benefit of priority from the prior Japanese Patent Application No. 2021-019468, filed on Feb. 10, 2021, the entire content of which is incorporated herein by reference.

### BACKGROUND OF THE INVENTION

### 1. Field of the Invention

The present invention relates to machine learning technologies.

### 2. Description of the Related Art

Transfer learning is known as a technology of adapting a model trained in a domain to another domain. In transfer learning, the domain that is a source is referred to as a source domain, and the domain that is a destination is referred to as a target domain. It is required to adapt a model trained in a source model to a target domain efficiently.

Patent document 1 discloses domain transformation neural networks configured to receive an input image from a source domain and process a network input comprising the input image from the source domain to generate a transformed image that is a transformation of the input image from the source domain to a target domain that is different from the source domain.
[patent document 1] JP2020-502665

When adapting a model trained in a source domain to a target domain in transfer learning, transfer learning has been performed by disregarding the property of the domain. This has led to a problem in that the quality of generalization of inference precision is lowered, or the volume of process grows unnecessarily large.

### SUMMARY OF THE INVENTION

The present disclosure addresses the issue described above, and a purpose thereof is to provide a machine learning technology capable of performing transfer learning in accordance with the property of a domain.

A machine learning device according to an aspect of the embodiment includes: a domain adaptation data richness determination unit that, when a first model trained by using training data of a first domain is trained by transfer learning by using training data of a second domain, determines a domain adaptation data richness based on the number of items of training data of the second domain, the first model being a neural network; a learning layer determining unit that determines a layer in the second model, which is a duplicate of the first model, targeted for training, based on the domain adaptation data richness; and a transfer learning unit that applies transfer learning to the layer in the second model targeted for training, by using the training data of the second domain.

Another mode of the embodiment relates to a machine learning method. The method includes: when a first model trained by using training data of a first domain is trained by transfer learning by using training data of a second domain, determining a domain adaptation data richness based on the number of items of training data of the second domain, the first model being a neural network; determining a layer in the second model, which is a duplicate of the first model, targeted for training, based on the domain adaptation data richness; and applying transfer learning to the layer in the second model targeted for training, by using the training data of the second domain.

Optional combinations of the aforementioned constituting elements, and implementations of the embodiment in the form of methods, apparatuses, systems, recording mediums, and computer programs may also be practiced as additional modes of the present disclosure.

### BRIEF DESCRIPTION OF THE DRAWINGS

FIG. 1 shows a configuration of a machine learning device and an inference device according to the embodiment;

FIG. 2 shows a detailed configuration of the transfer learning unit of the machine learning device of FIG. 1;

FIG. 3 shows a structure of a neural network model used as a source model and a target model in the machine learning device of FIG. 1;

FIG. 4 shows layers in the target model that are targeted for training in accordance with the domain adaptation data richness;

FIG. 5 shows further exemplary layers that are targeted for training in accordance with the domain adaptation data richness;

FIG. 6 shows further exemplary layers that are targeted for training in accordance with the domain adaptation data richness; and

FIG. 7 is a flowchart showing a sequence of machine learning steps executed by the machine learning device of FIG. 1.

### DETAILED DESCRIPTION OF THE INVENTION

The invention will now be described by reference to the preferred embodiments. This does not intend to limit the scope of the present invention, but to exemplify the invention.

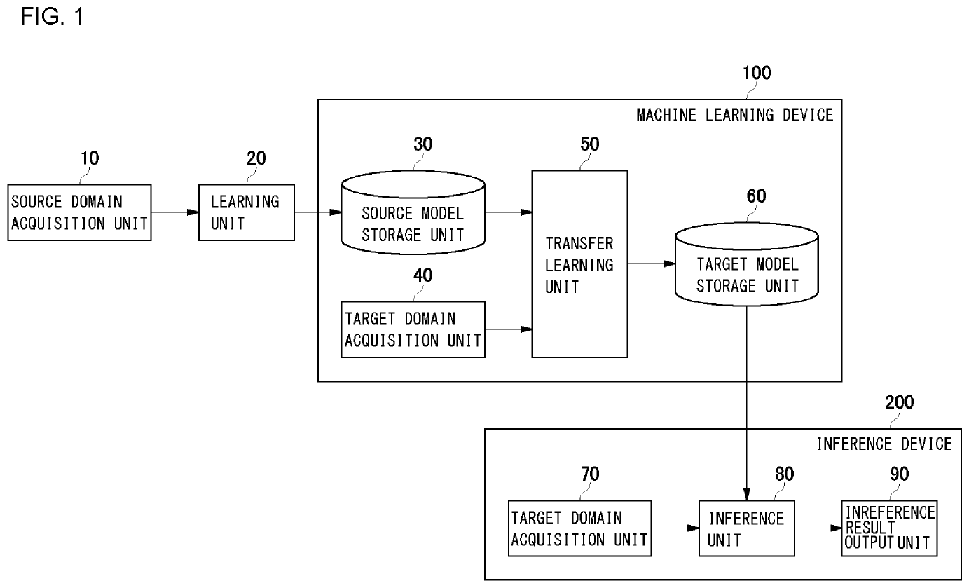

FIG. 1 shows a configuration of a machine learning device 100 and an inference device 200 according to the embodiment. The machine learning device 100 includes a source model storage unit 30, a target domain acquisition unit 40, a transfer learning unit 50, and a target model storage unit 60. The inference device 200 includes a target domain acquisition unit 70, an inference unit 80, and an inference result output unit 90.

Transfer learning is one of machine learning methods and is a method of adapting a model trained for a first task having sufficient data to learning of a second task related to the first task but not having sufficient data. Transfer learning can transfer the knowledge learned on the basis of sufficient data to a further task and so makes it possible to obtain highly precise results for the second task not having much data.

In transfer learning, a case in which the input domain of the first task and the input domain of the second task are of the same type and differ only in probability distribution is referred to as “domain adaptation”.

The input domain of the first task that is a source of transfer is referred to as “source domain”, and the input domain of the second task that is a destination of transfer is referred to as “target domain”. Further, the model trained for the first task is referred to as “source model”, and the model trained for the second task is referred to as “target model”.

In one example of domain adaptation, it is preferable to use, as the source domain, computer graphics (CG) and Web images, for which it is easy to collect data, and to use, as the target domain, real images captured by a camera or the like. The forms of the source domain and the target domain are not limited to these.

By training the source model using a large quantity of CG images as the source domain and using images captured by the camera as the target domain, transfer learning from the source model is performed in domain adaptation to generate a target model. It will be assumed here that classes included in the domain are exemplified by persons, cars, bicycles, dogs, and motorcycles, and the task is categorization.

The machine learning device 100 is a device to generate a target model by transfer learning, based on a trained source model and a target domain.

The source domain acquisition unit 10 acquires, as the source domain, CG images of persons, cars, bicycles, dogs, and motorcycles in a quantity sufficiently large to train the source model to categorize persons, cars, bicycles, dogs, and motorcycles with high precision.

The learning unit 20 uses the source domain to train a neural network model by machine learning to generate a source model and stores the generated source model in the source model storage unit 30. The source model can categorize the source domain with high precision.

The source model stored in the source model storage unit 30 is a trained source model used as a model at the source of transfer in transfer learning. The source model is a neural network model.

The target domain acquisition unit 40 acquires, as the target domain, images of persons, cars, bicycles, dogs, and motorcycles captured by a camera. The target domain generally has a smaller quantity of data than the source domain.

The transfer learning unit 50 uses the target domain acquired by the target domain acquisition unit 40 to generate a target model by applying transfer learning to the source model stored in the source model storage unit 30. The transfer learning unit 50 stores the generated target model in the target model storage unit 60.

The target model stored in the target model storage unit 60 is a trained model generated by transfer learning. The target model is a neural network model. The target model is derived from re-training a part of the source model at the source of transfer that is duplicated, by using the target domain.

The inference device 200 is a device that infers from and categorizes images by using the target model generated by the machine learning device 100. The inference device 200 is provided with, for example, an imaging unit, infers from images acquired from the imaging unit, and outputs a result of inference.

The target domain acquisition unit 70 acquires the target domain targeted for inference and supplies the target domain to the inference unit 80. The inference unit 80 infers from the target domain based on the target model stored in the target model storage unit 60 and outputs a result of inference to the inference result output unit 90. The inference result output unit 90 outputs the categorization resulting from the inference.

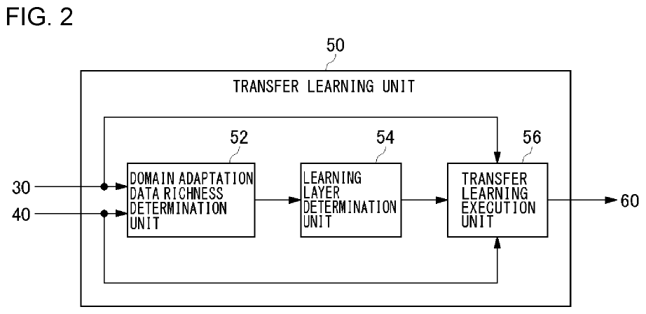

FIG. 2 shows a detailed configuration of the transfer learning unit 50 of the machine learning device 100. The transfer learning unit 50 includes a domain adaptation data richness determination unit 52, a learning layer determination unit 54, and a transfer learning execution unit 56.

The domain adaptation data richness determination unit 52 determines domain adaptation data richness based on the number of items training data in the target domain.

More specifically, the domain adaptation data richness is a ratio between the number of items of training data in a class in the target domain in which class the per-class number of items of training data is the smallest and the predetermined number of items of training data TDNUM. The predetermined number of items of training data is the number of items of training data sufficient to perform learning accurately. The predetermined number of items training data depends on the neural network model. It is assumed here that the neural network model is VGG16 and the predetermined number of items of training data is 3000. The precision of learning according to the number of items of training data may be measured in advance by using the training data of the source domain, and the number of items of training data resulting in a precision higher than the desired precision may be used as the predetermined number of items of training data. The domain adaptation data richness is preferably calculated by the following equation. MIN(N,M) is a function to select the smallest value of n or m. In this case, the domain adaptation data richness is a value not smaller than 0 and not larger than 1. Domain adaptation data richness=MIN(1,(number of items of training data in a class, in the target domain, with the smallest number of items of training data)/TDNUM).

The learning layer determination unit 54 determines a layer in the target model (a neural network model) targeted for training, based on the domain adaptation data richness.

To be specific, the learning layer determination unit 54 may ensure that the higher the domain adaptation data richness, the larger the number of layers in the target model targeted for training, and, the lower the domain adaptation data richness, the smaller the number of layers in the target model targeted for training.

The learning layer determination unit 54 may include a larger number of layers from higher layers (layers near the input) to lower layers (layers near the output) as targets of training when the domain adaptation data richness is higher, and, may define a smaller number of layers toward lower layers (layers near the output) to be targets of training when the domain adaptation data richness is lower. In other words, the learning layer determination unit 54 includes more of the layers near the input layer as layers targeted for training, as the domain adaptation data richness becomes higher.

The learning layer determination unit 54 may determine only full-connected layers in the target model to be layers targeted for training when the domain adaptation data richness is equal to or lower than a predetermined value.

Thus, when the domain adaptation data richness is low, i.e., when the number of items of training data is small, it is possible, by training only lower layers in the target model, to adapt the source model to the target model such that the generalization capability of detailed feature extraction of higher layers in the source model is maintained and to maintain the precision of the target model trained by transfer learning at a high level. Conversely, when the domain adaptation data richness is high, i.e., when the number of items of training data is large, it is possible, by training a large number of layers in the target model, to increase the precision of the target model trained by transfer learning.

The transfer learning execution unit 56 uses images of the target domain as training data to apply transfer learning to the layer(s) of the target model determined by the learning layer determination unit 54 to be targeted for training. Those layers other than the layers determined to be targeted for training are layers that are not trained. The layers of the duplicated source model are used as they are without being newly trained.

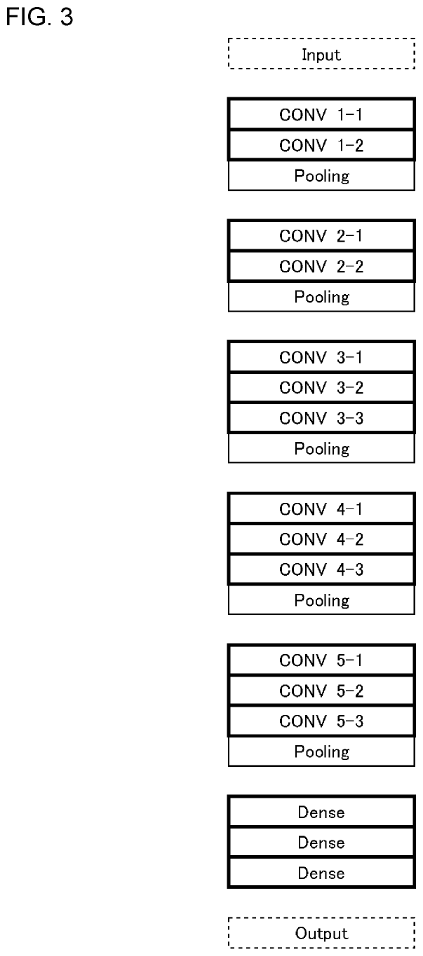

FIG. 3 shows a structure of a neural network model used as a source model and a target model in the machine learning device 100.

In the embodiment, the source model and the target model are assumed to be a neural network model VGG16. VGG16 is comprised of 13 convolutional layers (CONV), 3 fully-connected layers (Dense), and 5 pooling layers. The layers that are targeted for training include convolutional layers and full-connected layers. The pooling layer is a layer that sub-samples the feature map output from the convolutional layer. The source model and the target model are not limited to VGG16, and the number of layers is not limited to that of the embodiment.

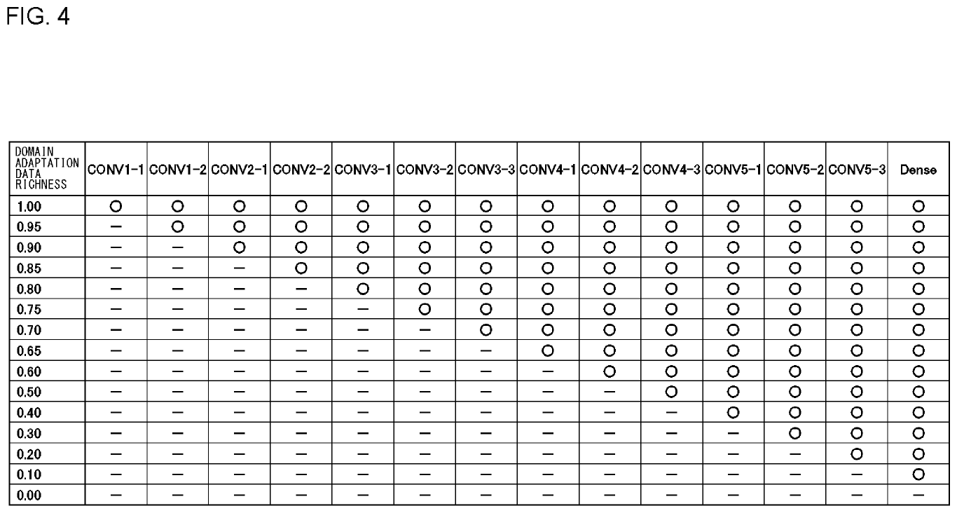

FIG. 4 shows layers in the target model that are targeted for training in accordance with the domain adaptation data richness.

When the domain adaptation data richness is 1.00, all layers are targeted for training. When the domain adaptation data richness is less than 1.00 and equal to more than 0.95, the layers other than CONY-1 are targeted for training. A duplicate of the layer CONV1-1 of the source model is used as it is. When the domain adaptation data richness is less than 0.95 and equal to or more than 0.90, the layers other than CONV1-1 and CONV1-2 are targeted for training. The duplicates of the layers CONV1-1 and CONV1-2 of the source model are used as they are. The rest remains the same, and, when the domain adaptation data richness is less than 0.10 and equal to or more than 0.00, none of the layers are targeted for training. In this case, the duplicates of all layers in the source model are used as they are.

Thus, the higher the domain adaptation data richness, the larger the number of convolutional layers, including those near the input layer, are targeted for training, and, the lower the domain adaptation data richness, the smaller the number of convolutional layers, and, those near the output layer, are targeted for training.

The relationship between the domain adaptation data richness and the layers targeted for training is not limited to the one described above. What is required is that the higher the domain adaptation data richness, the larger the number of layers from higher layers (layers near the input) to lower layers (layers near the output) are targeted for training, and the lower the domain adaptation data richness, the smaller the number of layers, and, lower layers (layers near the output), are targeted for training. Dense denotes the 3 full-connected layers. In this case, 3 full-connected layers are bundled for the purpose of control, but they may be controlled one by one as in the case of convolutional layers. In addition, the domain adaptation data richness is defined as a ratio between the number of items of training data in a class in the target domain in which class the per-class number of items of training data is the smallest and the predetermined number of items of training data TDNUM. However, the domain adaptation data richness may be the number of items of training data in a class in the target domain in which class the per-class number of items of training data is the smallest.

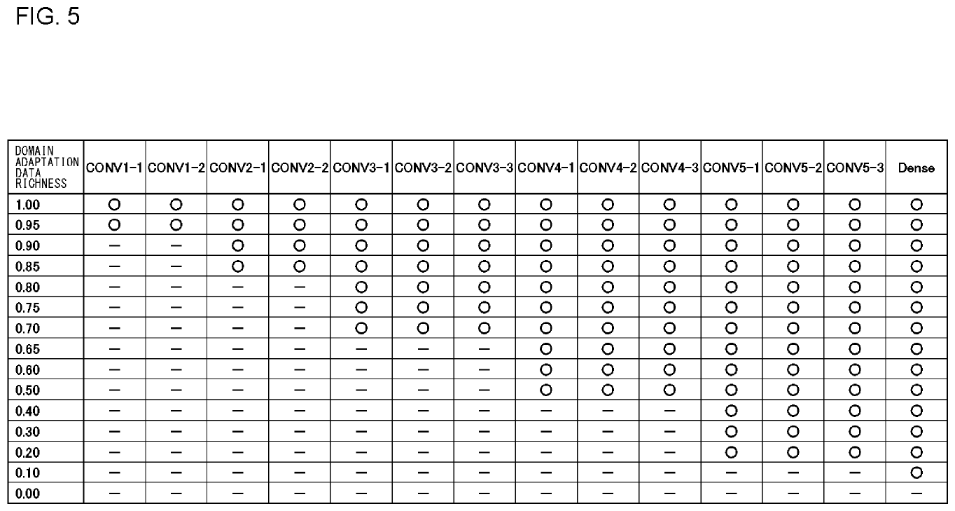

FIG. 5 shows further exemplary layers that are targeted for training in accordance with the domain adaptation data richness.

In the example shown in FIG. 5, a plurality of convolutional layers are bundled in units of pooling layers for the purpose of control. For example, the two convolutional layers CONV1-1 and CONV1-2 are bundled into one and are targeted for training when the domain adaptation data richness is not higher than 1.00 and not lower than 0.95, and the two convolutional layers CONV2-1 and CONV2-2 are bundled into one and are targeted for training when the domain adaptation data richness is not higher than 1.00 and not lower than 0.85. The rest remains the same, and two adjacent convolutional layers are bundled into one and are targeted for training. With the above configuration, it is possible to maintain feature extraction of the source model for each resolution of the feature map.

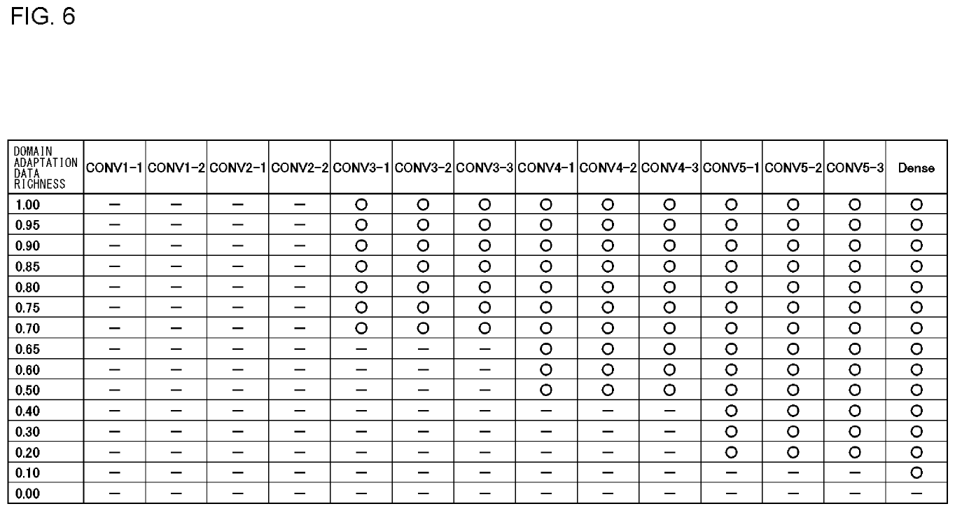

FIG. 6 shows further exemplary layers that are targeted for training in accordance with the domain adaptation data richness.

In the example shown in FIG. 6, layers near the input layer are not targeted for training invariably. In this case, the four convolutional layers CONV1-1, CONV1-2, CONV2-2, and CONV2-2 near the input layer are not targeted for training. With regard to the other convolutional layers, the smaller the domain adaptation data richness, the smaller the number of convolutional layers, and, those near the output layer, are targeted for training.

This improves the precision and reduces the volume of computation by exploiting edge-level detailed feature extraction of the source model as it is and by starting with adapting a feature that is, to a degree, abstract in nature to the target domain.

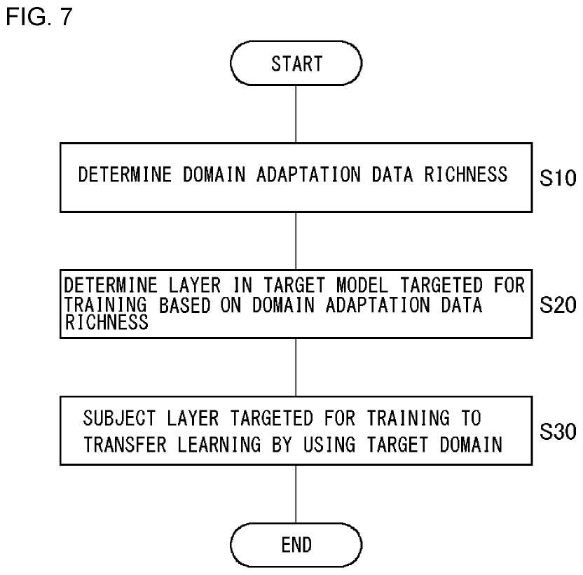

FIG. 7 is a flowchart showing a sequence of machine learning steps executed by the machine learning device of FIG. 1.

The domain adaptation data richness determination unit 52 of the transfer learning unit 50 of the machine learning device 100 determines the domain adaptation data richness based on the number of items of training data of the target domain (S10).

The learning layer determination unit 54 determines the layer in the target model, which is a duplicate of the source model, targeted for training, based on the domain adaptation data richness (S20).

The transfer learning execution unit 56 applies transfer learning to the layer in the target model targeted for training, by using images of the target domain as training data (S30).

The above-described various processes in the machine learning device 100 and the inference device 200 can of course be implemented by hardware-based devices such as a CPU and a memory and can also be implemented by firmware stored in a read-only memory (ROM), a flash memory, etc., or by software on a computer, etc. The firmware program or the software program may be made available on, for example, a computer readable recording medium. Alternatively, the program may be transmitted and received to and from a server via a wired or wireless network. Still alternatively, the program may be transmitted and received in the form of data broadcast over terrestrial or satellite digital broadcast systems.

As described above, it is possible, according to the machine learning device 100 of the embodiment, to generate a target model adapted to the property of the domain, having high a processing efficiency, and having a high inference precision and generalization capability, by changing the layer in a neural network of the target model trained by transfer learning in accordance the domain adaptation data richness based on the number of items of training data of the target domain.

Described above is an explanation based on an exemplary embodiment. The embodiment is intended to be illustrative only and it will be understood by those skilled in the art that various modifications to combinations of constituting elements and processes are possible and that such modifications are also within the scope of the present invention.

What is claimed is:

1. A machine learning device comprising:
a domain adaptation data richness determination unit that, when a first model trained by using training data of a first domain is trained by transfer learning by using training data of a second domain, determines a domain adaptation data richness based on the number of items of training data of the second domain, the first model being a neural network;
a learning layer determining unit that determines a layer in the second model, which is a duplicate of the first model, targeted for training, based on the domain adaptation data richness; and
a transfer learning unit that applies transfer learning to the layer in the second model targeted for training, by using the training data of the second domain.

2. The machine learning device according to claim 1, wherein
the learning layer determination unit ensures that the higher the domain adaptation data richness, the larger the number of layers targeted for training, and the lower the domain adaptation data richness, the smaller the number of layers targeted for training.

3. The machine learning device according to claim 1, wherein
the learning layer determination unit includes more of layers near an input layer as layers targeted for training, as the domain adaptation data richness becomes higher.

4. The machine learning device according to claim 1, wherein
the learning layer determination unit determines only full-connected layers to be layers targeted for training when the domain adaptation data richness is equal to or lower than a predetermined value.

5. A machine learning method comprising:
when a first model trained by using training data of a first domain is trained by transfer learning by using training data of a second domain, determining a domain adaptation data richness based on the number of items of training data of the second domain, the first model being a neural network;
determining a layer in the second model, which is a duplicate of the first model, targeted for training, based on the domain adaptation data richness; and
applying transfer learning to the layer in the second model targeted for training, by using the training data of the second domain.

6. A non-transitory computer-readable recording medium having embodied thereon a machine learning program comprising computer-implemented modules including:
a module that, when a first model trained by using training data of a first domain is trained by transfer learning by using training data of a second domain, determines a domain adaptation data richness based on the number of items of training data of the second domain, the first model being a neural network;
a module that determines a layer in the second model, which is a duplicate of the first model, targeted for training, based on the domain adaptation data richness; and
a module that applies transfer learning to the layer in the second model targeted for training, by using the training data of the second domain.
